(19) United States
(12) Patent Application Publication
(10) Pub. No.: US 2021/0279573 A1
(43) Pub. Date: Sep. 9, 2021

(54) DETECTING WHEN A PIECE OF MATERIAL IS CAUGHT BETWEEN A CHUCK AND A TOOL

(71) Applicant: Robert Bosch GmbH, Stuttgart (DE)

(72) Inventors: Mohamed-Ali Tnani, Neu-Ulm (DE); Benjamin Menz, Floersbachtal (DE); Scott Hibbard, Chicago, IL (US)

(21) Appl. No.: 17/188,757

(22) Filed: Mar. 1, 2021

Related U.S. Application Data
(60) Provisional application No. 62/985,170, filed on Mar. 4, 2020.

(51) Int. Cl. G06N 3/08; G06N 3/04

(52) U.S. Cl. CPC G06N 3/08; G06N 3/04

(57) ABSTRACT

A system for detecting material caught between a chuck and a removable tool. The system includes a sensor mounted on a surface that experiences a vibration caused by a rotating of the removable tool in the chuck. The system also includes an electronic processor configured to receive raw vibration data from the sensor, generate transformed vibration data by transforming the raw vibration data, and using a machine learning model, analyze the raw vibration data and transformed vibration data to determine whether there is a piece of material caught between the removable tool and the chuck.

### RELATED APPLICATIONS

This application is related to and claims the benefit of and priority to U.S. Provisional Patent Application Ser. No. 62/985,170, filed Mar. 4, 2020, titled “DETECTING WHEN A PIECE OF MATERIAL IS CAUGHT BETWEEN A CHUCK AND A TOOL” (Attorney Docket No. 022896-3233-US01), the disclosure of which is hereby incorporated herein by reference as if set forth in its entirety.

### BACKGROUND

Machining equipment, such as milling machines, often include a spindle chuck into which different tools can be inserted. Equipped with these tools milling machines can be used to form objects, for example, machine parts.

### SUMMARY

FIG. 1A shows a tool 100 (for example, a cutting tool) in a chuck 105. In some embodiments, the chuck is connected to a spindle that is turned by a motor (for example, as part of a computer numerical control (CNC) machine). In FIG. 1A, the tool 100 is aligned with the chuck 105. As illustrated in FIG. 1B, sometimes during the manufacturing process, a small piece of material 110, such as a metal chip, becomes stuck between the tool 100 and the chuck 105. For example, a metal chip may become lodged between the chuck 105 and tool 100 when the tool 100 in the chuck 105 is changed either manually or automatically. The lodged chip may change the angle of the tool 100 in the chuck 105 as illustrated in FIG. 1B. Thus, the piece of material may cause the tool 100 to become misaligned with the chuck 105 and, as a result, make inaccurate cuts, tap inaccurate holes, or both. In some cases, the misalignment of the tool 100 in the chuck 105 may cause damage to the tool 100, the spindle, the chuck 105, other parts of the machine operating the tool, or a combination of the foregoing. It should be noted that the tool 100, although not illustrated herein, may include both a tool and a tool holder.

Existing systems use sensors mounted (via, for example, a bearing) on the spindle connecting the chuck to the motor and limit-based monitoring to determine when a piece of material is caught between the chuck and the tool. However, these existing systems are not easily used on older or legacy machines, and the hardware used to attach the sensor to the spindle often fails. Additionally, these existing systems suffer from limited scalability and required defined measuring cycles, which cause downtime. Some existing systems require connection to a machine control system to determine when monitoring should take place (when is a tool in use), which tool is in use, or both. Some existing systems use different models for determining whether material is caught between a tool and a chuck depending on the tool in use and need to determine which tool is in use in order to select the correct model. Connecting to the machine control system is complex and requires customization for the different hardware of each machine control system vendor and each machine setup.

Therefore, embodiments herein describe, among other things, a system and method for detecting when a piece of material is caught between a chuck and a tool. Certain embodiments described herein utilize machine learning software to determine when a piece of material is caught between the chuck and the tool based on vibration data from a sensor mounted on a surface of the machine (for example, a motor housing). Certain embodiments described herein do not require a sensor to be mounted on the spindle and overcome many of the aforementioned deficiencies of existing systems. Additionally, the embodiments described herein do not require connection to machine control systems because they use vibration data to determine when a tool is in use and a machine learning model to determine, for a variety of different tools, whether a piece of material is caught between a tool and a chuck.

For example, one embodiment provides a system for detecting material caught between a chuck and a removable tool. The system includes a sensor mounted on a surface that vibrates. The vibration of the surface is caused by a rotating of the removable tool in the chuck. The system also includes an electronic processor configured to receive raw vibration data from the sensor, generate transformed vibration data by transforming the raw vibration data, and using a machine learning model, analyze the raw vibration data and transformed vibration data to determine whether there is a piece of material caught between the tool and the chuck.

Another embodiment provides a method for detecting material caught between a chuck and a tool. The method includes receiving raw vibration data from a sensor mounted on a surface that vibrates. The vibration of the surface is caused by a rotating of the removable tool in the chuck, generating transformed vibration data by transforming the raw vibration data, and using a machine learning model, analyzing the raw vibration data and transformed vibration data to determine whether there is a piece of material caught between the tool and the chuck.

Yet another embodiment provides a method for detecting material caught between a chuck and a removable tool. The method includes receiving raw vibration data from a sensor mounted on a surface that vibrates. The vibration of the surface is caused by an operation of the removable tool in the chuck and using a machine learning model, analyzing raw vibration data, transformed vibration data generated from the raw vibration data, or both to determine whether there is a piece of material caught between the removable tool and the chuck.

Other aspects, features, and embodiments will become apparent by consideration of the detailed description and accompanying drawings.

### BRIEF DESCRIPTION OF THE DRAWINGS

FIG. 1A illustrates an example of a tool in a chuck when there is no piece of material caught between the tool and the chuck.

FIG. 1B illustrates an example of a tool in a chuck when there is a piece of material caught between the tool and the chuck.

FIG. 2 is a block diagram of a system for detecting when a piece of material is caught between a chuck and a tool according to one embodiment.

FIG. 3 is a block diagram of a local computer of the system of FIG. 1 according to one embodiment.

FIG. 4 is an example illustration of training data used to train the machine learning model utilized during the execution of the method of FIG. 5 according to one embodiment.

FIG. 5 is a flowchart of a method of using the system of FIG. 2 to detect when a piece of material is caught between a chuck and a tool according to one embodiment.

FIG. 6 is a block diagram of a neural network used to perform the method of FIG. 5 according to one embodiment.

FIG. 7 is an illustration of raw vibration data and resulting predictions according to one embodiment.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware devices and software, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more communication interfaces, one or more application specific integrated circuits (ASICs), and various connections (for example, a system bus) connecting the various components. It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

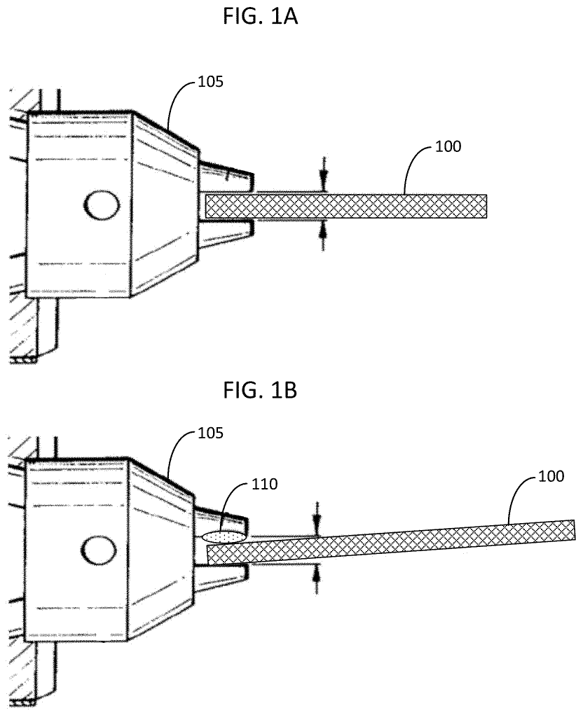

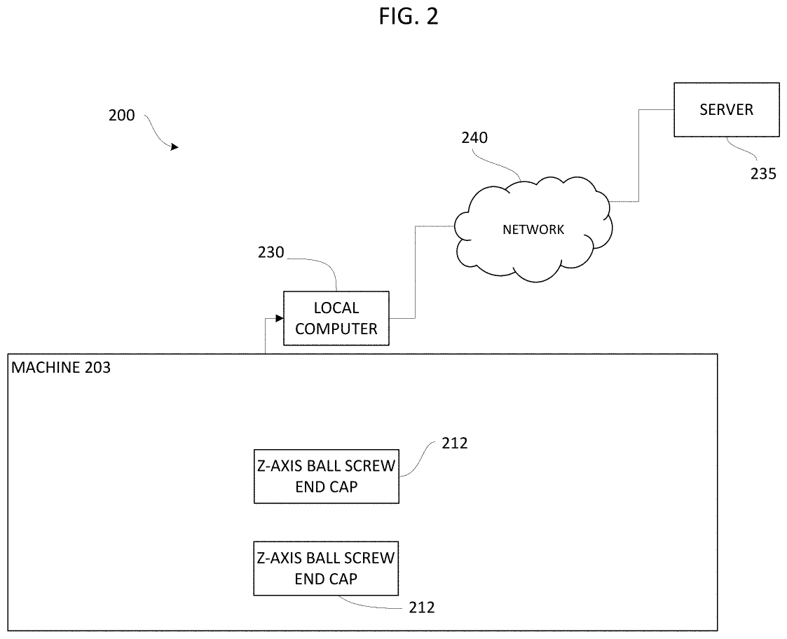

FIG. 2 illustrates a system 200 for detecting when a piece of material is caught between a chuck and a tool. In the example provided, the system 200 includes a machine 203 with a motor/motor housing 205, a z-axis ball screw 210, a z-axis ball screw end cap 212, a chuck 215, a tool 220, and a sensor 225. The system 200 also includes a local computer 230 (an edge device) and a server 235. In some embodiments, the machine 203 is a computer numerical control (CNC) machine. In some embodiments, the local computer 230 is included in the machine 203. The motor 205 included in the machine 203 drives the z-axis ball screw 210 and the z-axis ball screw 210 translates the rotary motion of the motor 205 to linear motion to change the z-axis. The chuck 215 connects the z-axis ball screw 210 to the tool 220 so that when the motor 205 turns, the tool 220 moves. The chuck 215 allows different tools to be connected to the z-axis ball screw 210. The tool 220 attached to the chuck 215 may be changed automatically or manually. In one example, the tool 220 is a turning tool capable of forming objects such as mechanical components out of a piece of material by cutting away at the material. When the tool 220 cuts the material, chips are generated which can get stuck between the tool 220 and the chuck 215 causing misalignment of the tool 220, such as the misalignment shown in FIG. 1B.

The sensor 225 is a vibration sensor, capable of measuring the vibrations generated by the moving tool 220. For example, the sensor 225 may be a Structure-Borne Sound Sensor (SB SS) or a Connected Industrial Sensor Solution (CISS) manufactured by Robert Bosch LLC. The sensor 225 is communicatively connected to the local computer 230 and sends vibration data to the local computer 230 via various wired or wireless connections. For example, in some embodiments, the sensor 225 is directly coupled via a dedicated wire to the local computer 230. In other embodiments, the sensor 225 is communicatively coupled to the local computer 230 via a shared communication link such as a Bluetooth™ or other wireless connection. In some embodiments, the sensor 225 is mounted to the motor housing 205. In other embodiments, the sensor 225 is mounted to the z-axis ball screw end cap 212, an x-axis ball screw end cap (not shown), or a y-axis ball screw end cap (not shown).

The local computer 230 and the server 235 communicate over one or more wired or wireless communication networks 240. Portions of the wireless communication networks 240 may be implemented using a wide area network, such as the Internet, a local area network, such as a Wi-Fi network, short-range wireless networks, such as a Bluetooth™ network, near field communication connections, and combinations or derivatives thereof. In alternative embodiments, the server 235 is part of a cloud-based system external to the system 200 and accessible by the local computer 230 over one or more additional networks.

It should be noted that while certain functionality described herein as being performed by one component of the system 200, in some embodiments that functionality may be performed by a different component of the system 200 or a combination of components of the system 200. It should be understood that the system 200 may include a different number of machines (for example, milling machines) each with a sensor, a different number of local computers, and a different number of servers than the single machine 203, local computer 230, and server 235 illustrated in FIG. 2.

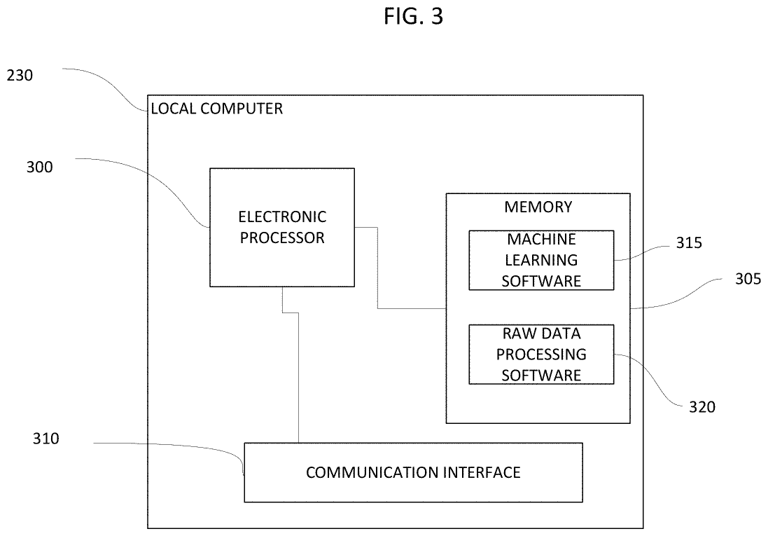

FIG. 3 is a block diagram of one example embodiment of the local computer 230 of the system 200 of FIG. 2. The local computer 230 includes, among other things, an electronic processor 300 (such as a programmable electronic microprocessor, microcontroller, or similar device), a memory 305 (for example, non-transitory, machine readable memory), and a communication interface 310. The electronic processor 300 is communicatively connected to the memory 305 and the communication interface 310. The electronic processor 300, in coordination with the memory 305 and the communication interface 310, is configured to implement, among other things, the methods described herein.

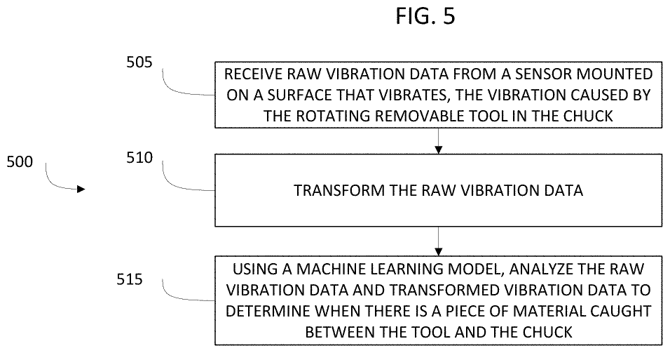

The memory 305 includes software that, when executed by the electronic processor 300, causes the electronic processor 300 to perform the method 500 illustrated in FIG. 5. For example, the memory 305 illustrated in FIG. 3 includes machine learning model 315 and raw data processing software 320. The machine learning model 315 may be a deep neural network (for example, a convolutional neural network (CNN) or a recurrent neural network (RNN)). In one example, the neural network includes two input channels, allowing the neural network to analyze both raw vibration data and vibration data transformed by the raw data processing software 320 simultaneously to detect when a piece of material is caught between a chuck and a tool. As described below, in some embodiments, the neural network may include a different number of channels than two channels illustrated and described herein.

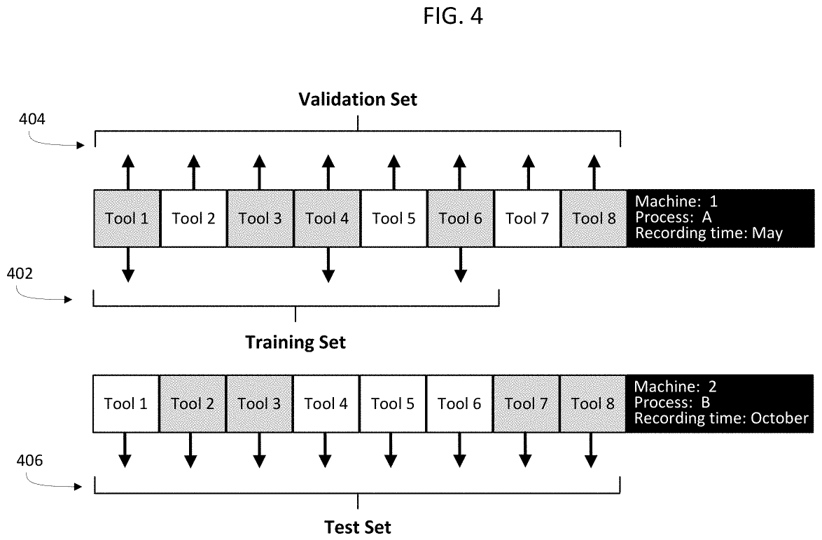

In some embodiments, the machine learning model 315 is trained to detect when a piece of material is caught between a chuck and a tool using training data including samples or snippets of vibration data that have been labeled to indicate whether or not they are indicative of a piece of material being caught between a tool and a chuck. The training data includes a training set, a validation set, and a test set. The training set is a set of vibration data samples or snippets used to train the machine learning model 315 (for example, to determine weights and biases in the machine learning model 315). The validation set is a set of vibration data samples or snippets used to evaluate the machine learning model 315 after each training epoch and test the loss and accuracy of the machine learning model 315 on unseen data. The test set is a set of vibration data samples or snippets used to provide an unbiased evaluation of the final machine learning model 315 and define the degree of generalization of the machine learning model 315. The training data includes data vibration data from a variety of different machines, using a variety of tools in a variety of states of wear while manufacturing a variety of different objects. The training data may include raw vibration data and transformed vibration data. FIG. 4 provides a visual representation of one example of training data. As illustrated in FIG. 4, the training set 402, validation set 404, and test set 406 may each be different sets of vibration data collected from different machines, using different tools of different ages to manufacture different objects. The vibration data samples for tools illustrated in FIG. 4 having a darker shade represent tools which possess both good process measurements (e.g., vibrations generated by the machine operating without material caught in the chuck) and defect process measurements (e.g., vibrations generated by the machine operating with material is caught in the chuck). The process measurements of the tools that are shared by the train and the validation dataset are split between both datasets. Using such varied training data produces a model trained to detect material caught between a chuck and a tool across a variety of conditions and circumstances.

In some embodiments, the training data is segmented into snippets allowing the number of training samples having a standard length to be increased. Dataset segmentation consists of slicing a signal into smaller segments (i.e., snippets), which allow enlargement of the training population with samples having a standard length. Each snippet has a window size. For vibration data, drive motor speed and sensor sampling rate should be considered when determining the window size. In some embodiments, a window size is set to cover at least one full revolution of the motor (i.e., the selected window should contain the periodical spatial position of the drive motor). In some embodiments, the window size is determined according to the following formula:

$$Window {Size}_{min} = \frac{Sampling Frequency}{Rotational {Speed}_{max}} \qquad ( 1 )$$

In some embodiments, each snippet is smaller (for example, half of the window size). In some embodiments, the training data is downsampled. Downsampling is utilized to increase the performance of some neural networks (for example, Long Short-Term Networks) by using smaller window sizes. In some embodiments, the training data is normalized using, for example, Standard-Scaling.

In some embodiments, the training data is collected via one or more local computers such as the local computer 230 and sent to the server 235. The server 235 uses the received training data to train a machine learning model 315 and, when the machine learning model 315 is trained, sends the machine learning model 315 to each local computer in the system 200. When the local computer 230, executing the machine learning model 315, cannot determine whether vibration data is indicative of a piece of material being caught between a tool and a chuck, the local computer 230 may send a notification to the server 235 (for example, using a suitable network message or an application programming interface). In some embodiments, the notification may include the vibration data and a label that the machine operator has associated with the vibration data. In response to receiving the notification, the server 235 may retrain the machine learning model 315 and send the retrained machine learning model to each of the local computers in the system 200. Therefore, the machine learning model deployed to each local computer improves over time from collective awareness and the initial training time needed to apply the machine learning model to monitoring a new machine is reduced.

Although not illustrated herein, the server 235 may contain components similar to those illustrated in FIG. 3 as being included in the local computer 230. The functionality described herein as being performed by the local computer 230 or the server 235 may be distributed amongst a plurality of local computers and servers. Additionally, the local computer 230, the server 235, or both may contain sub-modules that include additional electronic processors, memory, or application specific integrated circuits (ASICs) for handling communication functions, processing of signals, and application of the methods listed below. In other embodiments, the local computer 230, server 235, or both include additional, fewer, or different components than those illustrated in FIG. 3.

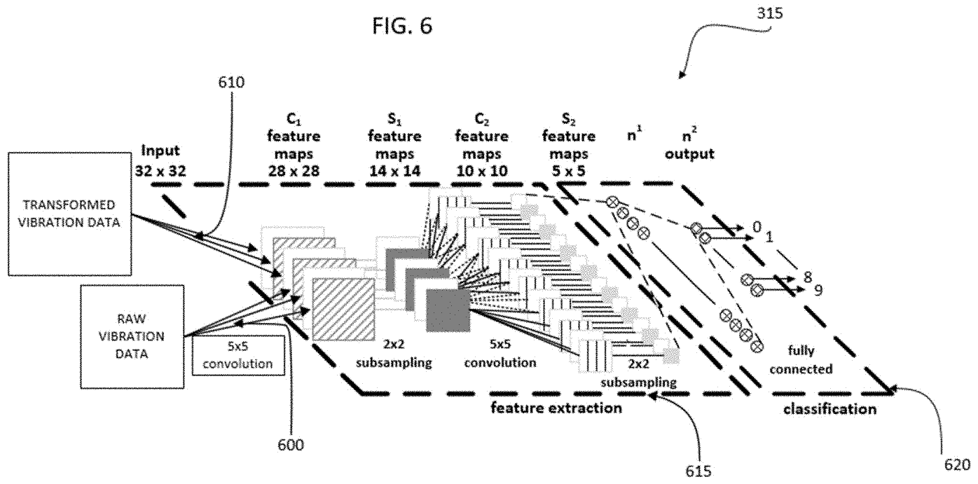

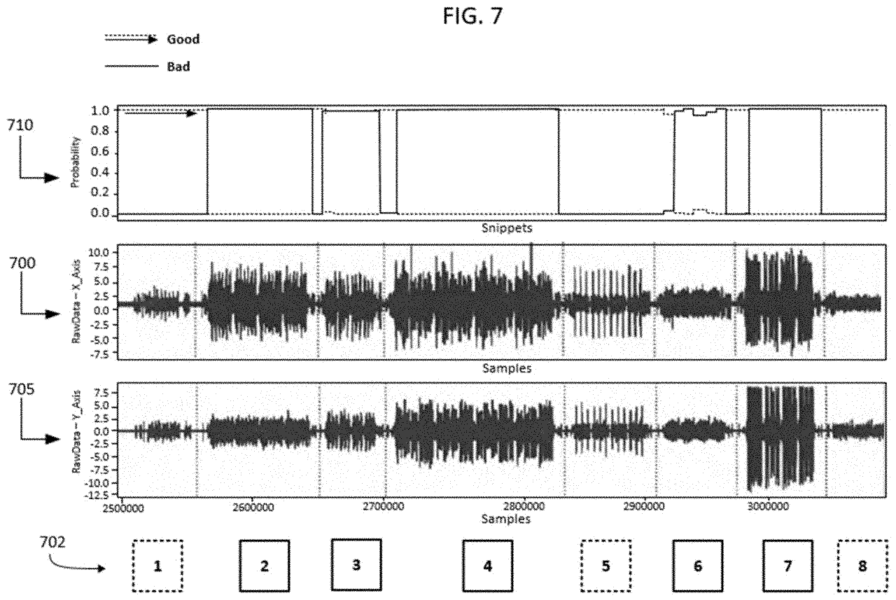

FIG. 5 illustrates an example method 500 of detecting when a piece of material is caught between a chuck and a tool. At step 505, the electronic processor 300 receives raw vibration data from a sensor mounted on a surface of the machine 203 that experiences a vibration. In some embodiments, the vibration is caused by a removable tool (for example, the tool 220) rotating in the chuck 215. For example, the sensor 225 may capture the movement of the motor housing 205 or z-axis ball screw end cap 212 in the x-direction, the y-direction, or both. In some embodiments, at step 510, the electronic processor 300 transforms the raw vibration data to produce transformed vibration data. For example, at step 510, the electronic processor 300 may execute the raw data processing software 320 to apply a Fast Fourier Transform to the raw vibration data received from the sensor 225. Applying a Fast Fourier Transform to the raw vibration data can reduce the dimensions of the input space by extracting the power spectral density series. At step 515, the electronic processor 300, using a machine learning model (for example, the machine learning model 315), analyzes the raw vibration data and transformed vibration data to determine when there is a piece of material caught between the tool 220 and the chuck 215. In some embodiments, as explained in detail with regard to FIGS. 6 and 7, the machine learning model 315 uses a neural network to predict whether the raw vibration data and transformed vibration data are indicative of vibrations caused by a tool and chuck operating with a piece of material caught between them. FIG. 6 illustrates one example of how the electronic processor 300 (at step 515) determines when a piece of material is caught between the chuck 220 and the tool 220. In the example illustrated in FIG. 6, the machine learning model 315 is illustrated as a convolutional neural network with two input channels. In the example illustrated in FIG. 6, raw vibration data in the x-direction is fed to the neural network as a signal via a first channel 600 and transformed vibration data in the x-direction is fed to the neural network as a signal via a second channel 610.

The neural network has a plurality of layers including feature extraction layers 615 and a classification layer 620. There are two types of feature extraction layers 615—convolutional layers and pooling or sub-sampling layers. Each convolutional layer applies filters to the raw and transformed vibration data in the x-direction. In certain embodiments, a filter is a matrix of weight values. The weight values of the filters are set by training the neural network. Sub-sampling layers reduce the size of the input data or signals being processed by the neural network. A sub-sampling layer creates a smaller portion from a larger signal by creating the smaller signal with patterns that represent groups of patterns in the larger signal. The classification layer 620 is responsible for using the extracted features of the raw and transformed vibration data in the x-direction detecting when a piece of material is caught between a chuck and a tool.

It should be understood that the machine learning model 315 may receive different input via the two input channels than the raw and transformed vibration data in the x-direction illustrated in FIG. 6. For example, the machine learning model 315 may receive raw and transformed vibration data in the y-direction, raw vibration data in the x-direction and transformed vibration data in the y-direction, or raw vibration data in the y-direction and transformed vibration data in the x-direction. It should be understood that different combinations of vibration data, other than those described herein, may be received by the machine learning model 315 via two input channels. It should also be understood that the machine learning model 315 may be a neural network with a different number of channels than the two channels illustrated in FIG. 6. For example, the machine learning model 315 may be a neural network with a single input channel and the neural network may receive raw vibration data in the x-direction, raw vibration data in the y-direction, transformed vibration data in the y-direction, or transformed vibration data in the x-direction via the single input channel. In another example, the machine learning model 315 may be a neural network with four input channels and receive raw vibration data in the x-direction, raw vibration data in the y-direction, transformed vibration data in the y-direction, and transformed vibration data in the x-direction via the four input channels. It should be understood that the machine learning model 315 may be a neural network with a different number of channels than those described in the examples presented herein. Additionally, the machine learning model 315 may receive different input via the input channels than the inputs described in the examples presented herein.

FIG. 7 is an example illustration of raw vibration data in the x-direction 700 for tools 702 (labeled 1 through 8), raw vibration data in the y-direction 705 for tools 702 (labeled 1 through 8), and a prediction 710 (made by the machine learning model 315 using raw vibration data in the x-direction 700 and raw vibration data in the y-direction 705) as to whether a piece of material is caught between a chuck and a tool. In the example illustrated in FIG. 7, tools with numbers outlined in dashes (in FIG. 7, tools 1, 5, and 8) are determined to be rotating without a piece of material caught between the chuck and the tool and tools with numbers outlined in a solid line (in FIG. 7, tools 2, 3, 4, 6, and 7) are determined to be rotating with a piece of material caught between the chuck and the tool.

In some embodiments, when a piece of material is determined to be caught between the chuck 215 and the tool 220, the electronic processor 300 is configured to send a signal to interrupt the machining process (for example, using a suitable message protocol or discrete signal), send a signal to cause a notification indicating that there is a piece of material caught between the chuck 215 and the tool 220 to a user (for example, a technician), a combination of the foregoing, and the like. For example, the user may be notified of the existence of the piece of the material via a user interface of a user device or the local computer 230. In some embodiments, interrupting the machining process includes preventing the machine 203 from manufacturing any further objects until a human operator approves the machine 203 for further manufacturing.

Embodiments described herein are described in terms of detecting a piece of material caught between a chuck and a tool during a rotation of the tool by the chuck and a spindle. However, it should be understood that the embodiments may be used to detect piece(s) of material caught between a chuck, clamp (for example, a blade clamp), or other tool holder and a tool held by the chuck, clamp, or holder during non-rotational movements of a tool by a machine. In one non-limiting example, a tool (for example, a saw blade) used in a reciprocating motion may generate vibrations during the operation of the tool that can be used to determine whether material is caught in the tool holder (for example, a blade clamp). Systems and methods described herein are also applicable to machines operating such tools.

In the foregoing specification, specific embodiments and examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

Various features, advantages, and embodiments are set forth in the following claims.

What is claimed is:

1. A system for detecting material caught between a chuck and a removable tool, the system comprising:
a sensor mounted on a surface that experiences a vibration caused by a rotating of the removable tool in the chuck; and
an electronic processor, the electronic processor configured to
receive raw vibration data from the sensor;
generate transformed vibration data by transforming the raw vibration data; and
using a machine learning model, analyze the raw vibration data and transformed vibration data to determine whether there is a piece of material caught between the removable tool and the chuck.

2. The system according to claim 1, wherein the machine learning model includes a convolutional neural network.

3. The system according to claim 2, wherein the convolutional neural network includes a first channel whereby the convolutional neural network receives the raw vibration data for analysis and a second channel whereby the convolutional neural network receives the transformed vibration data for analysis.

4. The system according to claim 1, wherein the sensor is a vibration sensor.

5. The system according to claim 1, wherein the electronic processor is further configured to send a first signal to interrupt a machining process send a second signal to cause a notification indicating that the piece of material is caught between the chuck and the removable tool to be sent to a user, or both.

6. The system according to claim 1, wherein the electronic processor is included in a local computer and the electronic processor is configured to receive the machine learning model from a server.

7. The system according to claim 6, wherein the server is configured to train the machine learning model using vibration data collected from one or more different machines, using one or more different tools of one or more different ages to manufacture one or more different objects.

8. The system according to claim 1, wherein the electronic processor is configured to transform the raw vibration data by applying a Fast Fourier Transform to the raw vibration data.

9. A method for detecting material caught between a chuck and a removable tool, the method comprising:
receiving raw vibration data from a sensor mounted on a surface that experiences a vibration caused by a rotating of the removable tool in the chuck;
generating transformed vibration data by transforming the raw vibration data; and
using a machine learning model, analyzing the raw vibration data and transformed vibration data to determine whether there is a piece of material caught between the removable tool and the chuck.

10. The method according to claim 9, wherein the machine learning model includes a convolutional neural network.

11. The method according to claim 10, wherein the convolutional neural network includes a first channel whereby the convolutional neural network receives the raw vibration data for analysis and a second channel whereby the convolutional neural network receives the transformed vibration data for analysis.

12. The method according to claim 9, wherein the sensor is a vibration sensor.

13. The method according to claim 9, the method further comprising sending a first signal to interrupt a machining process, sending a second signal to cause a notification indicating that the piece of material is caught between the chuck and the removable tool to be sent to a user, or both.

14. The method according to claim 9, the method further comprising receiving, with a local computer, the machine learning model from a server.

15. The method according to claim 14, wherein the server is configured to train the machine learning model using vibration data collected from one or more different machines, using one or more different removable tools of one or more different ages to manufacture one or more different objects.

16. The method according to claim 9, wherein transforming the raw vibration data includes applying a Fast Fourier Transform to the raw vibration data.

17. A method for detecting when material caught between a chuck and a removable tool, the method comprising:
receiving raw vibration data from a sensor mounted on a surface that experiences a vibration caused by an operation of the removable tool in the chuck; and
using a machine learning model, analyzing at least one selected from the group consisting of the raw vibration data and transformed vibration data generated from the raw vibration data to determine whether there is a piece of material caught between the removable tool and the chuck.
